(19) United States
(12) Patent Application Publication
(10) Pub. No.: US 2004/0182781 A1
(43) Pub. Date: Sep. 23, 2004

(54) Method and apparatus for in-situ microbial seeding of wastes

(76) Inventors: Tommy Mack Davis, Spartanburg, SC (US); Cecil Allen McEntire, Whitmire, SC (US)

Correspondence Address: TED M. ANTHONY, Perret Doise, APLC, Suite 1200, 600 Jefferson Street, Lafayette, LA, 70501, US

(21) Appl. No.: 10/391,936

(22) Filed: Mar. 19, 2003

(51) Int. Cl. C02F 3/00

(52) U.S. Cl. 210/615; 210/150

(57) ABSTRACT

A method and apparatus is provided for the continuous microbial remediation of organic contaminants typically found in sewerage and other wastes utilizing in-situ microbial seeding. A bio-reactor containing microbially inoculated carrier media is attached to an existing treatment device (e.g. septic tank) providing liquid/solids separation. Air and nutrients are supplied to the bio-reactor, ideally from a remote, easily accessible location. Beneficial microbial populations are permitted to thrive and spread throughout the waste-laden environment, mineralizing such organic wastes.

### BACKGROUND OF THE INVENTION

1. Field of the Invention

The present invention pertains to a method and apparatus for the treatment of waste discharged and/or originating from septic tanks and other similar facilities subsequent to solids separation. More particularly, the present invention pertains to a method and apparatus for in-situ microbial treatment of liquid waste from septic tanks and other similar facilities subsequent to solids separation.

2. Description of the Related Art

Water treatment facilities in general, and residential sewer systems in particular, are frequently confronted with many different types of problems. One especially prevalent problem, particularly in certain geographical areas, is the lack of appropriate soils to provide a treatment area or “drain field” for wastewater contaminants. This lack of suitable soils for the establishment of drain fields often results in the need for more sophisticated, and frequently much more expensive, treatment methodologies. In some cases, the lack of suitable drain field conditions can result in outright rejection of property for certain proposed uses.

As communities grow, residential and commercial development frequently spreads to previously undeveloped areas. When such areas lack suitable soils or other conditions necessary for the establishment of drain fields, conventional treatment facilities such as septic tanks and the like generally cannot be utilized. In such cases, alternative methods of wastewater treatment must be employed. Such alternative wastewater treatment methods are often very expensive, as well as difficult and time consuming to operate and maintain. As a result, there is a need for an inexpensive, reliable and relatively simple means for treating septic tank discharge in areas or locations which cannot support conventional drain fields.

It is well known that certain microbes can be beneficially used to naturally mineralize or break down organic matter into harmless and/or environmentally-friendly elements, such as carbon dioxide and water. Furthermore, it is also well known that certain microbes can be used to beneficially control or eliminate malodorous and/or toxic elements found in certain waste streams, including domestic grey-water and other effluent from waste treatment facilities. However, to date, existing microbial treatment methods have not been used to effectively or reliably treat effluent from septic tanks or other similar facilities so as to eliminate or reduce the need for conventional drain fields and the like.

A number of patents describe methods and devices which utilize microbes to treat organic wastes. Several of these patents disclose inventions that are immersed or submerged directly into the waste-laden environments to be treated. Examples of such patents include U.S. Pat. No. 4,670,149 to Francis; U.S. Pat. No. 4,810,385 to Hater, et al.; U.S. Pat. No. 4,925,564 to Francis; U.S. Pat. No. 5,516,687 to Perez, et al., U.S. Pat. No. 5,911,877 to Perez, et al.; U.S. Pat. No. 5,879,932 to Van Erdewyk, et al.; U.S. Pat. No. 5,935,843 to Glendening, et al.; and U.S. Pat. No. 6,248,234 to Cline. However, unlike the invention described herein, the devices described in the aforementioned patents still require periodic addition, that is “dosing”, of microbial cultures directly into the environment to be treated. Without such dosing, the beneficial microbial populations will not remain at effective levels.

U.S. Pat. No. 5,314,620 to Staniec describes a method and apparatus for the use of microbes to purify cutting oil, such as lubricants used in metal machining equipment. The '620 patent describes means for aerating such cutting oil in order to encourage growth of aerobic bacteria, and to discourage the growth of unwanted anaerobic bacteria. However, the method and apparatus described in the '620 patent do not provide for direct aeration of the beneficial microbial populations, or the addition of nutrients directly to said microbial populations. Furthermore, because cutting oil is kept in a relatively small reservoir, the method and apparatus described in the '620 patent does not promote beneficial microbial spreading throughout larger environments, or the treatment of a high volume effluent stream.

U.S. Pat. No. 4,994,391 to Hoffmann discloses a system utilized to produce active bacteria to breakdown chemical or biological wastes in effluent steams. The system described in the '391 Patent utilizes a combination of a culturing basin and an acclimator basin in a temperature-controlled space. The culturing basin contains numerous components, such as a series of removable nutrient suspension means and a vertical collection pipe with holes. The bacteria are cultured in the presence of the nutrient suspension means as bacteria are pumped out of one or two of the culturing basins into an acclimator basin. The system disclosed in the '391 Patent is significantly more complicated and expensive to use than the present invention.

U.S. Pat. No. 6,207,047 to Gothreaux describes a wastewater treatment system. However, the apparatus disclosed in the '047 patent requires one or more pumps to move fluid(s) throughout the system. By contrast, the present invention is significantly less complicated since, in many applications, a liquid waste stream can be gravity-fed through the present invention. Further, the '047 patent describes anaerobic treatment of wastes in the absence of oxygen, while the present invention specifically utilizes oxygen to promote the treatment of wastes as described herein.

Thus, there is a need for an inexpensive, effective and reliable means to treat septic tank discharge, such as grey-water and the like, with microbial populations in order to reduce or eliminate the need for conventional drain fields and/or similar facilities. Such microbial populations must be able to beneficially attack organic materials for waste remediation purposes, yet still be able to overcome limitations associated with simple periodic dosing of microbial agents. Further, the system must be able to handle unexpected or periodic slugs of concentrated wastes or other toxic substances without experiencing a system upset or other prolonged treatment disruption.

### SUMMARY OF THE INVENTION

The present invention provides a method and apparatus for continuous microbial seeding of waste-laden discharge from septic tanks and similar facilities in order to reduce or eliminate the need for conventional drain fields and the like. As such, the present invention represents an improvement in the overall performance of existing microbial waste treatment systems. By promoting in-situ growth of desired microbial populations directly within an environment to be treated, the present invention allows for demand growth and microbial acclimation based on waste content within said environment. Because the microbial agents generated by the present invention are provided with a continuous supply of oxygen and/or nutrients, such microbial agents can more effectively mineralize waste within an environment being treated. Performance of the present invention far surpasses performance of existing methods of waste remediation which employ simple “dosing” of microbial populations.

Throughout the specification and claims reference is made to “treatment of wastes from septic tanks and other facilities”. This phrase and other similar terminology is intended to be broad and to include use of the present invention in connection with the broadest possible range of applications. For example, the present invention can be used in connection with both residential and commercial sewage treatment plants, as well as other similar facilities. Moreover, while the present invention is effective for use with septic tanks serving individual residences, it can also be used with sewer treatment units serving multi-use structures and the like.

In one embodiment, the present invention comprises an “in-line” bio-reactor. Said bio-reactor is typically installed downstream of a septic tank or other similar waste treatment device. Although said bio-reactor can be in any number of configurations, in the preferred embodiment the bio-reactor is a generally cylindrical, elongate and substantially hollow container. Said container has a central bore or chamber, a concentric influent opening for receiving septic tank discharge, and an eccentric effluent aperture for discharging treated liquids. Additional ports exist on the bio-reactor unit to permit and regulate the addition of air and nutrients to said bio-reactor in order to promote beneficial microbial growth within said bio-reactor.

A conduit is provided which extends from the outside of said bio-reactor container through to the inner bore or chamber thereof. Said conduit extends into the inner chamber or bore of said bio-reactor container, where a diffuser having a plurality of apertures or openings is attached to said conduit. Within the inner bore or chamber of said bio-reactor container, said diffuser extends substantially along the entire length of the device. In the preferred embodiment, said conduit and diffuser are constructed of inert piping or tubing; said conduit and diffuser can be constructed from tubing that is commercially available in varying rigidity, diameters and lengths. Generally, the rigidity, diameter and length of the conduit and diffuser will be dictated by the specific air supply used and its proximity to the bio-reactor unit.

The bio-reactor container of the present invention is connected to an existing waste treatment device, such as a septic tank or the like, that serves to separate the liquid and solid fractions of a waste stream. As such, in the preferred embodiment, the bio-reactor container of the present invention is typically provided with unions and/or other fittings that allow said bio-reactor container to be readily attached to the outlet of an existing waste treatment unit (e.g. septic tank, Imhoff tank or other similar device) so as to receive waste-laden effluent discharged therefrom.

Microbially inoculated biocarrier is loaded within the inner bore of said bio-reactor container. Said biocarrier is held in place using permeable containment screens on each end of said bio-reactor container; said containment screens permit liquid flow therethrough, but not passage of said biocarrier. Although any number of different media can be used for such biocarrier, in the preferred embodiment such microbially inoculated biocarrier comprises one or more different types of granular ceramic media, such as are currently commercially available. Ideally, said biocarrier provides high surface area for microbial growth, while having sufficiently large dimensions to prevent such biocarrier from passing through said permeable containment screens. Said biocarrier is inoculated with microbial culture(s) specific to the degradation of waste(s) to be encountered within the particular environment being treated.

It should be noted that said microbially inoculated biocarrier is ideally loaded within the inner bore of said bio-reactor so that it substantially covers or engulfs all or substantially all of the diffuser which extends along the length of said bio-reactor container.

Air and nutrients are supplied to microbial population(s) present on the inoculated biocarrier which is loaded within the bio-reactor container. Although such air and nutrient sources can be placed in any number of different locations relative to said bio-reactor container, in the preferred embodiment of the present invention such air and nutrient sources are placed at a remote location. In many cases, such air and nutrient sources are beneficially situated at or near a residence or other facility being serviced by the present invention. Such placement typically allows for support by existing utilities, as well as easy access to said air pump and/or nutrient sources for maintenance and/or repair purposes. For example, in typical applications in which the bio-reactor of the present invention is installed downstream of a residential septic tank, an air pump and/or nutrient supply source would normally be located within, or in close proximity to, a residence or other facility being serviced by said septic tank and supported by the utilities associated with said residence or other facility.

Air and/or nutrients are transported through the conduit and into the diffuser which extends along the length of the bio-reactor container of the present invention. While the nutrients provided by said nutrient supply source(s) should be beneficially tailored to the specific microbial agents being used in a particular application, in the preferred embodiment such nutrients are typically some combination of nitrates and/or phosphates.

Air provided via the conduit, the diffuser and into the bio-reactor container serves to oxygenate beneficial microbial cultures present on the microbially inoculated biocarrier. Such oxygenation permits increased respiration by, and population expansion of, such beneficial microbes. Ultimately, this oxygenation allows the desired microbial cultures to thrive, thereby resulting in optimized mineralization of waste products within an environment being treated. Moreover, bubbles generated by air diffusing through the microbially inoculated biocarrier and the waste-laden liquid environment facilitates microbial bleed-off from the bio-reactor container to the surrounding environment, such as the inlet and outlet piping, thereby promoting increased mineralization of wastes throughout the system being treated.

Thus, the present invention provides continuous treatment of wastes using beneficial microbes within a waste-laden environment. Moreover, the present invention utilizes in-situ addition of microbes for this purpose. Such continuous microbial addition results in demand growth, thereby permitting optimized mineralization of wastes being treated, as well as acclimation of the microbes to such wastes. Over time, such beneficial microbes can frequently establish themselves as the dominant species within a particular environment being treated. Eventually, such microbes will colonize walls and other surfaces of structures housing the wastes being treated. Such colonization provides favorable conditions for further expansion of beneficial microbial agents through a waste-laden environment being treated.

In another embodiment of the present invention, an in-situ bio-reactor is located directly within a septic tank or other waste treatment unit, or in a separate chamber which is in communication therewith. In this embodiment, a bio-reactor unit is typically contained within a separate chamber of said septic tank or other unit, and immersed directly within the waste-laden liquid to be treated. In said embodiment, the bio-reactor of the present invention typically comprises a permeable container, such as a perforated or screened-cylinder, which houses microbially inoculated biocarrier. Perforations or openings in said container permit liquid flow therethrough, but prevent such biocarrier media from escaping from said container. A conduit and diffuser wand permit air and/or nutrients to reach the microbial populations present on the surface of said microbially inoculated biocarrier. Over time, the in-situ microbial growth provided by the present invention can result in the spread of beneficial microbial agents throughout the system(s) being treated including, without limitation, a septic tank or other similar unit.

This embodiment of the present invention functions in much the same way as the embodiment set forth above. However, one major difference between said embodiments is that the previous “in-line” embodiment is generally fitted to existing septic tanks or other facilities. The “immersible” embodiment, on the other hand, is typically installed directly within, or in connection with, septic tanks or other waste treatment devices.

Because beneficial microbial agents are continuously generated and become the dominant species throughout the systems utilizing the present invention, a large amount of wastes can be mineralized before liquids reach a point of ultimate discharge. Accordingly, waste-laden liquids treated with the present invention are generally much cleaner than liquids discharged from existing septic tanks and/or other waste treatment units. Furthermore, use of the present invention can reduce or eliminate the need for conventional drain fields, thereby permitting installation of septic tanks and similar units in a greater variety of settings.

### BRIEF DESCRIPTION OF THE DRAWINGS

FIG. 1 depicts a side view of one embodiment of the in-situ bio-reactor of the present invention installed in connection with a residential septic tank.

FIG. 2 depicts a side view of one embodiment of the in-situ bio-reactor of the present invention.

FIG. 3 depicts a side cut-away view of the in-situ bio-reactor embodiment shown in FIG. 2.

FIG. 4 depicts a partial side cut-away view of the in-situ bio-reactor embodiment shown in FIG. 2, including microbially inoculated bio-carrier.

FIG. 5 depicts a side cut-away view of another embodiment of the present invention having an in-situ bio-reactor contained within a conventional septic tank.

FIG. 6 depicts a side view of the in-situ bio-reactor shown in FIG. 5.

FIG. 7 depicts a partial side cut-away view of the in-situ bio-reactor shown in FIG. 6.

### DESCRIPTION OF THE PREFERRED EMBODIMENT(S)

a. “In-Line” Embodiment

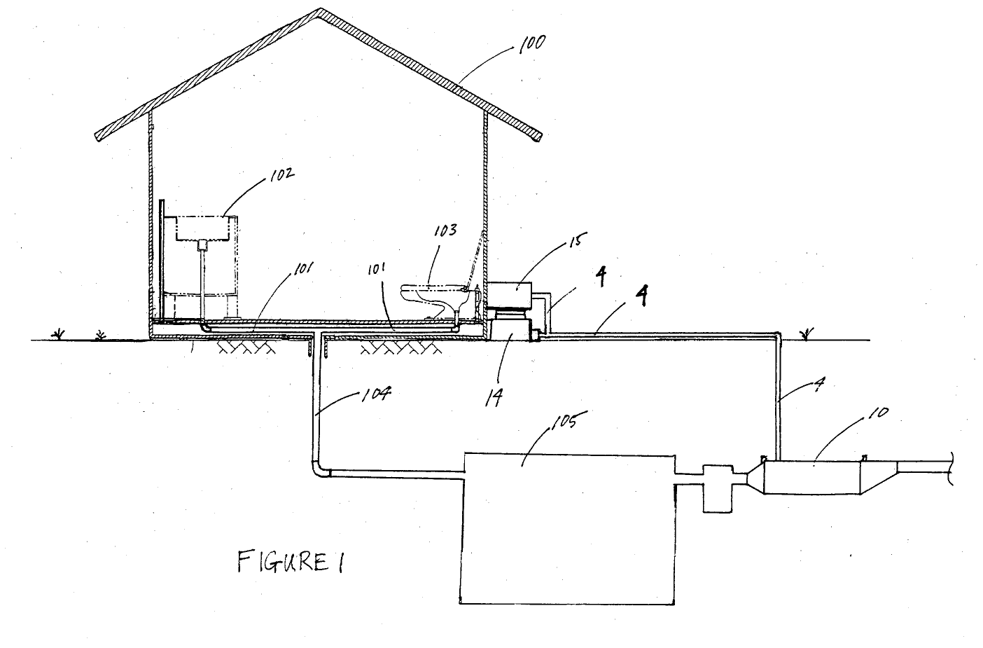

FIG. 1 depicts a side view of an “in-line” embodiment of the bio-reactor of the present invention installed in connection with a typical residential application. Dwelling 100 has waste pipes 101 servicing sink 102 and toilet 103. Waste materials contained within waste pipes 101 are ultimately commingled and carried via common drain line 104 to septic tank unit 105. In the application depicted in FIG. 1, septic tank unit 105 is installed underground in general proximity to dwelling 100. Bio-reactor 10 of the present invention is installed downstream of said septic tank unit 105. Said bio-reactor 10 receives liquids discharged from said septic tank unit 105. Conduit 4 extends from air blower 14 and nutrient source 15 to said bio-reactor 10. In the preferred embodiment, air blower 14 and nutrient source 15 are placed at a location near dwelling 10, and a single conduit 4 is used to transport air and nutrients to bio-reactor 10. However, it should be noted that separate conduit lines could be used for this purpose.

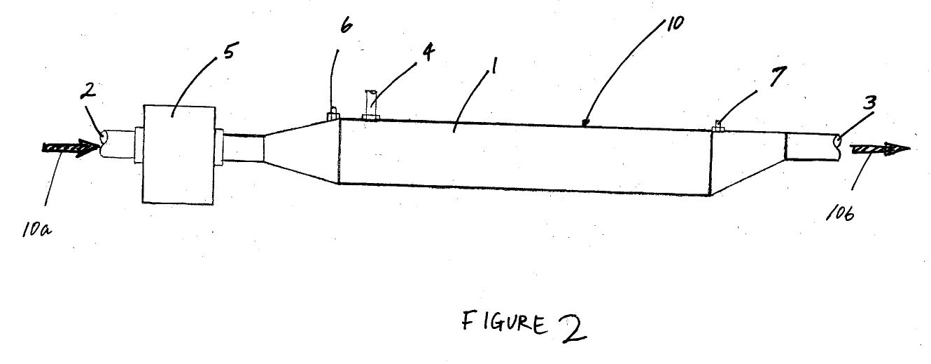

Referring to FIG. 2, a side view of said embodiment of the in-situ bio-reactor 10 of the present invention illustrated in FIG. 1 is depicted. Although such bio-reactor can comprise any number of different shapes or configurations, in the preferred embodiment said bio-reactor comprises an elongate, substantially cylindrical and hollow bio-reactor container 1 having a concentric influent aperture 2 and eccentric effluent aperture 3. Conduit 4 extends from the outside of said bio-reactor container 1 through to the internal bore or chamber thereof (not shown in this figure). Flow-through housing 5 is provided for inclusion of an optional in-line filter means, such as a bucket strainer or the like. Additionally, ports 6 and 7 are provided to permit communication with the inner bore or chamber of bio-reactor container 1. Said ports 6 and 7 allow connection of water or air hoses for optional rinsing and/or clean-out purposes as desired.

In-situ bio-reactor 10 of the present invention is typically installed downstream of a septic tank or other similar waste treatment unit. As such, in the preferred embodiment, bio-reactor 10 is located in close proximity to the outlet of such a septic tank or other unit. Specifically, concentric influent aperture is positioned so as to receive liquid discharge from said septic tank or other unit, and direct such liquid flow into bio-reactor container 1. Flow direction of such liquid effluent is depicted with arrows 10a and 10b in FIG. 2. Liquid waste is retained within bio-reactor container 1 and, after being treated, exits said bio-reactor container 1 via eccentric effluent aperture 3. In most applications, such waste liquid is gravity-fed into concentric influent aperture 2 and bio-reactor container 1.

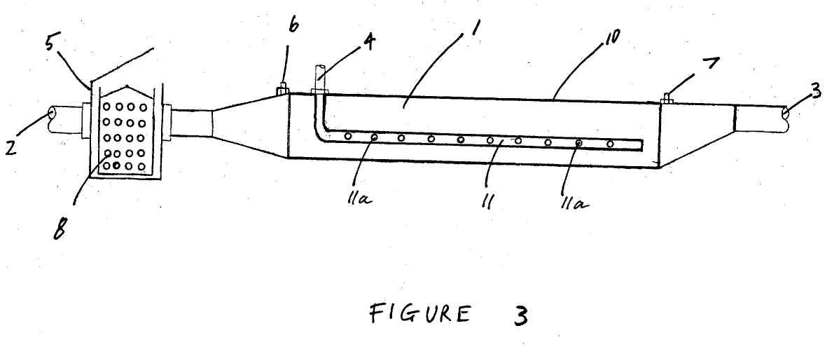

FIG. 3 depicts a side cut-away view of the in-situ bio-reactor embodiment shown in FIG. 2. Within the inner chamber of bio-reactor container 1, conduit 4 connects to diffuser 11. Diffuser 11, in turn, extends substantially along the entire length of said bio-reactor container 1. In the case of an elongate bio-reactor container 1 as depicted, said diffuser extends in a direction which is generally parallel to the longitudinal axis of said bio-reactor container 1. A plurality of apertures 11a extend through said diffuser 11 along the length thereof. In the preferred embodiment, conduit 4 and diffuser 11 are constructed of inert piping or tubing, such as is commercially available in varying rigidity, diameters and lengths. Generally, the rigidity, diameter and length of said conduit and diffuser will be dictated by the means used to supply via conduit 4, as well as the physical proximity of the air source in relation to said bio-reactor container 1.

Bio-reactor 10 of the present invention is beneficially installed downstream of an existing waste treatment device that serves to separate liquid and solid fractions of a waste stream. As such, in the preferred embodiment, bio-reactor container 1 of the present invention can be provided with unions and/or other fittings that allow said unit to be readily attached to the outlet or discharge line of existing waste treatment devices (typically septic tanks, Imhoff tanks or the like). Additionally, an optional filter means can be provided within housing 5 to further promote removal of solids and/or particulate matter from a waste stream entering bio-reactor container 1 via concentric influent aperture 2. In the preferred embodiment, said filter means comprises bucket strainer 8. However, any number of conventional filter/strainer devices can be installed in housing 5 and utilized for this purpose. Ports 6 and 7 can be used to flush air, water or another substance through bio-reactor container 1 for cleaning purposes.

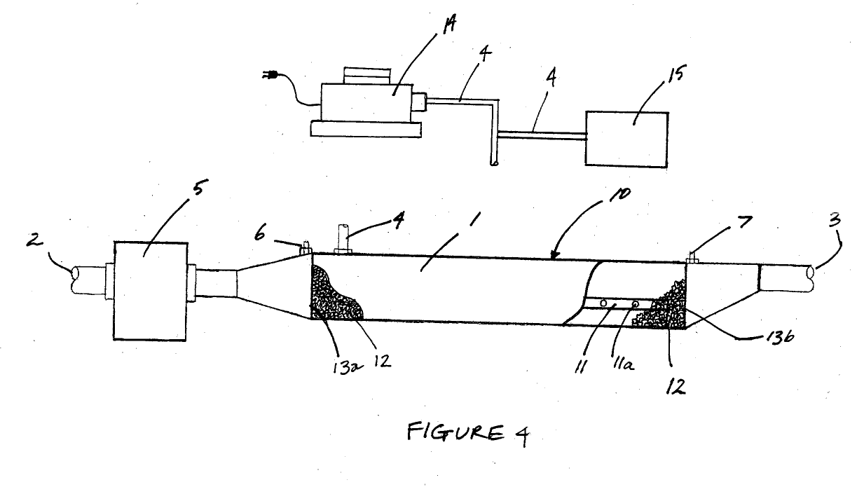

FIG. 4 depicts a partial side cut-away view of the in-situ bio-reactor embodiment shown in FIG. 2, including microbially inoculated bio-carrier 12. Prior to being introduced into an environment to be treated, microbially inoculated biocarrier 12 is inoculated with desired microbial population(s) and loaded within the inner chamber of cylindrical bio-reactor container 1. Said microbially inoculated biocarrier 12 is held in place using opposing, permeable containment screens 13a and 13b. Containment screen 13a is installed in close proximity to the inlet of said bio-reactor container 1, while another such screen 13b is installed near the outlet of said bio-reactor container 1. Containment screens 13a and 13b act as “book ends” to confine microbially inoculated biocarrier 12 within bio-reactor container 1. Containment screens 13a and 13b are sized to permit liquid flow therethrough, while preventing the passage of said microbially inoculated biocarrier 12 through the openings in said screens 13a and 13b.

Any number of different biocarrier media can be used in connection with the present invention. In the preferred embodiment, such microbially inoculated biocarrier 12 comprises one or more types of granular ceramic media, such as are currently commercially available. Ideally, said biocarrier 12 provides exceptionally high surface area for microbial growth, while exhibiting exterior dimensions sufficient to prevent such biocarrier from passing through the openings in containment screens 13a and 13b. Said biocarrier 12 is ideally inoculated with microbial population(s) which are beneficially tailored to the degradation of waste(s) to be encountered and treated within a particular environment, such as those encountered in effluent from septic tanks and other similar waste treatment units. Biocarrier 12 is ideally loaded within the inner chamber of bio-reactor container 1 so that said biocarrier 12 substantially fills said inner chamber of bio-reactor container 1, and more or less covers or engulfs diffuser 11 along its entire length.

Air and nutrients are supplied, via conduit 4 and, ultimately, diffuser 11 to the microbial population(s) present on inoculated bio-carrier 12. Air can be supplied by air compressor 14, and nutrients supplied by nutrient source 15. Air compressor 14 and nutrient source 15 can be situated in any number of different locations relative to said bio-reactor container 1. However, in the preferred embodiment of the present invention, air compressor 14 and nutrient source 15 are placed at a remote location which is not in immediate proximity to bio-reactor container 1. In most cases, such air and nutrient sources are placed at or near a dwelling or other site being serviced by bio-reactor 10 of the present invention. For example, in typical applications in which bio-reactor 10 is installed immediately downstream from the discharge line of a conventional septic tank, air compressor 14 and nutrient source 15 are located in close proximity to a dwelling or other structure being serviced by said septic tank. Conduit 4 is used to transport air and/or nutrients from such air and nutrient sources directly through conduit 4 and into diffuser 11 which extends within the inner bore of cylindrical bio-reactor container 1. While the nutrients provided by said nutrient source(s) should be beneficially tailored to the specific microbial agents being used in a particular application, in the preferred embodiment such nutrients typically comprise some combination of nitrates and/or phosphates.

Air provided through conduit 4 and diffuser 11 to bio-reactor container 1 generates bubbles which percolate through liquid waste stream and microbially inoculated biocarrier 12. Such air bubbles serve to oxygenate beneficial microbial cultures present on inoculated biocarrier 12 within bio-reactor container 1. Such oxygenation permits increased respiration and population expansion of said beneficial microbial cultures. Ultimately, such oxygenation allows the beneficial microbial cultures to thrive, thereby resulting in optimized mineralization of waste products within the environment being treated. Moreover, air bubbles generated by allowing air to diffuse through microbially inoculated biocarrier 12 and the waste-laden liquid facilitates microbial bleed-off from bio-reactor container 1 into the surrounding environment, which further promotes increased mineralization of waste products.

This embodiment of the present invention functions in the following manner. A waste stream exits a conventional septic tank or other similar unit via a septic tank discharge line. If functioning properly, said septic tank or other similar unit will act to separate solid wastes from the associated liquid waste stream. As a result, an effluent stream from said septic tank or other similar unit will be composed primarily of a liquid phase with minimal solid waste content.

Said liquid waste stream exiting a septic tank or other similar waste treatment unit flows into concentric influent aperture 2 of bio-reactor 10. The liquid waste stream passes through optional filter means, such as bucket strainer 8, in order to remove any additional solids or particulate matter which was not separated in said septic tank or other waste treatment unit. Thereafter, said liquid waste flows through containment screen 13 and into bio-reactor container 1.

Once inside bio-reactor container 1, such liquid waste permeates through microbially inoculated biocarrier 12. Beneficial microbial population(s) present on said inoculated biocarrier 12 come in contact with organic wastes present in said liquid waste stream. Such beneficial microbial population(s) act to mineralize such organic wastes, resulting in environmentally acceptable by-products (including, by way of illustration but not limitation, carbon dioxide and water). By the time that said liquid waste stream progresses through said bio-reactor container 1, the bulk of said organic wastes become mineralized and broken down into environmentally benign elements. The treated liquid stream passes through permeable containment screen 13b, and is ultimately discharged through eccentric effluent aperature 3.

In order to facilitate mineralization of wastes by beneficial microbial populations present on inoculated biocarrier 12, it is generally desirable that the liquid waste stream being treated have sufficient retention time within bio-reactor container 1. Such retention time promotes contact between beneficial microbial populations and the wastes which are being treated, thereby facilitating desired mineralization of said wastes. To this end, variables such as the length of said bio-reactor container 1 and/or the permeability characteristics of biocarrier 12 can be altered or manipulated in order to increase or decrease such retention time, as desired.

b. “Immersible” Embodiment

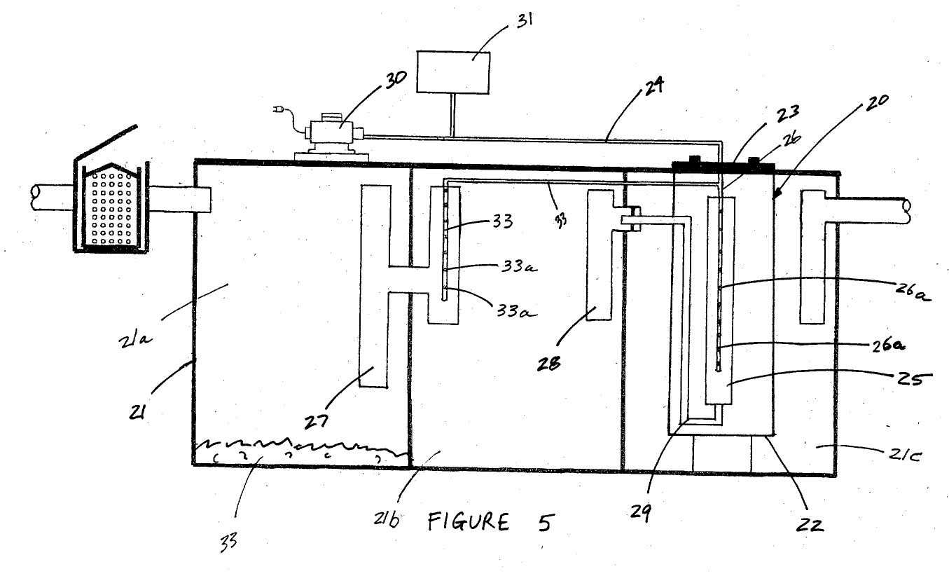

FIG. 5 depicts another embodiment of the bio-reactor of the present invention. In the preferred version of this embodiment, said bio-reactor is physically contained and immersed within a septic tank or other waste treatment unit. As shown in FIG. 5, bio-reactor 20 of the present invention is installed within a septic tank 21. Septic tank 21 has a plurality of distinct chambers or compartments, 21a, 21b and 21c. Although bio-reactor 20 can be any number of different shapes or sizes, in the preferred version of this embodiment, said immersible bio-reactor 20 comprises a substantially cylindrical and substantially hollow container 22. Said bio-reactor container 22 is permeable, and includes one or more openings which permit communication between the external surface and the internal chamber of said bio-reactor container 22. In the preferred embodiment, the body of said bio-reactor container 22 is constructed of wire-wrapped screen or similar permeable material. Alternatively, the walls of said bio-reactor container 22 can be formed of mesh or other permeable material. Although bio-reactor 20 can be installed within septic tank 21 in any number of ways and/or configurations, in the preferred embodiment, bio-reactor container 22 is suspended within septic tank 21 using upper cap 23. Generally, it is beneficial to suspend said bio-reactor container 22 directly within the waste-laden environment to be treated.

Conduit 24 extends to said hollow bio-reactor container 22. In the preferred embodiment, said conduit 24 is constructed of inert tubing. However, many different types of tubing or piping are commercially available in varying rigidity, diameters and lengths, and can be used for such conduit 24. Conduit 24 connects to diffusion wand 26, which in turn extends within the inner bore of hollow bio-reactor container 22. Perforated diffusion tube 25, having an inner bore, is supported within the inner chamber of cylindrical bio-reactor container 22. Diffusion wand 26 is concentrically received within the inner bore of said perforated diffusion tube 25. One or more apertures 26a extend through diffusion wand 26 along the length thereof. Additionally, conduit 24 can also be routed to provide optional air wand 33, having a plurality of apertures 33a.

Microbially inoculated biocarrier, not depicted in FIG. 5, is loaded within the inner bore of bio-reactor container 22. Any number of different biocarrier media can be utilized for this purpose. In the preferred embodiment, said microbially inoculated biocarrier comprises one or more varieties of commercially available ceramic media providing high surface area for microbial growth. Such biocarrier must have sufficient outer dimensions to prevent loss or passage of such biocarrier through apertures in bio-reactor container 22. Prior to being loaded within bio-reactor container 22, said biocarrier is inoculated with one or more desired microbial population(s) beneficially tailored to mineralize waste(s) to be encountered and treated within a particular environment to be treated.

Still referring to FIG. 5, equalization tubes 27 and 28 allow liquid transfer between compartments of said septic tank unit 21. In the three (3) compartment septic tank unit 21 depicted in FIG. 5, solid wastes 33 generally fall out of suspension and collect within first compartment 21a of said septic tank unit 21. As compartment 21 a fills with liquid, said liquid is directed to compartment 21b via equalization tube 27. Similarly, as compartment 21b fills with liquid, said liquid is directed to chamber 21c via equalization tube 28. Specifically, flow tube 29 directs liquid flow from equalization tube 28 into perforated diffusion tube 25.

Air compressor 30 provides an air supply to cylindrical bio-reactor container 22 via conduit 24 and diffusion wand 26. Although air compressor 30 can be situated in any number of different locations relative to said cylindrical bio-reactor container 22, in the preferred embodiment of the present invention said air source is placed at a remote location. Air from air compressor 30 travels through conduit 24 and diffusion wand 26 which extends into cylindrical bio-reactor container 22. Similarly, conduit 24 can also be used to transport nutrients from nutrient source 31 to said cylindrical bio-reactor container 22 and, thus, to the microbial population(s) present on inoculated biocarrier media contained within said bio-reactor container 22.

The present invention promotes continuous in-situ growth and flourishing of beneficial microbial populations directly within a waste-laden environment to be treated. Such continuous microbial addition results in demand growth, thereby permitting optimized mineralization of wastes being treated. Over time, beneficial microbial populations will establish themselves as the dominant species within the particular waste-laden environment being treated. Such colonization provides favorable conditions for further expansion of beneficial microbial agents through the overall system being treated which, in turn, promotes improved mineralization of wastes.

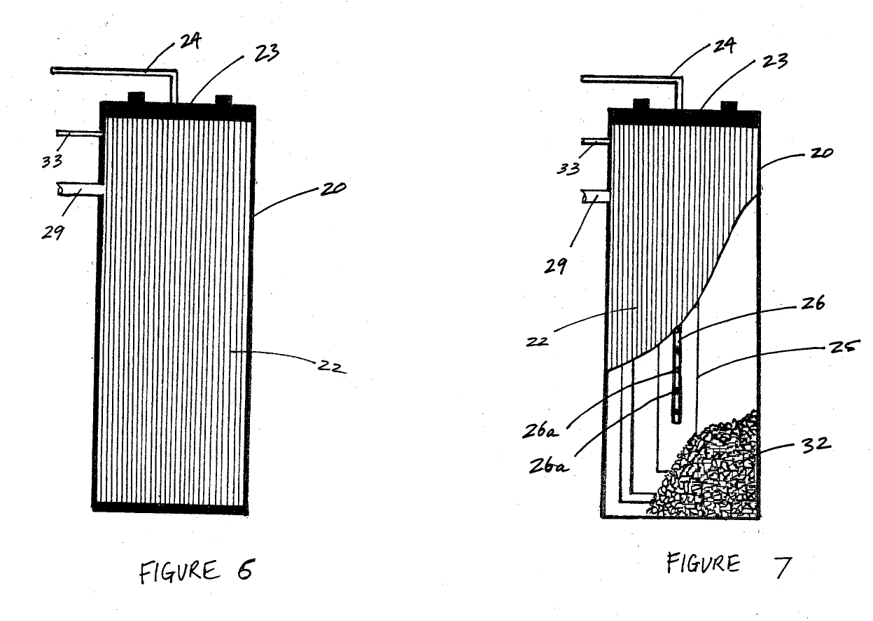

FIG. 6 depicts a side view of the in-situ bio-reactor 20 shown in FIG. 5. The outer surface of cylindrical bio-reactor container 22 is constructed of permeable slotted screen material. Conduit 24 extends into bio-reactor container 22 through upper cap 23. Flow tube 29 and optional air wand 33 extend through the side of bio-reactor container 22.

FIG. 7 depicts a partial side cut-away view of the in-situ bio-reactor 20 shown in FIG. 5, including microbially inoculated bio-carrier 32. Prior to bio-reactor 20 being installed into an environment to be treated, microbially inoculated biocarrier 32 is loaded within the inner bore of cylindrical bio-reactor container 22. Any number of different biocarrier media can be used for this purpose. In the preferred embodiment, such microbially inoculated biocarrier 32 is one or more granular ceramic media, such as are currently commercially available. Ideally, microbially inoculated biocarrier 32 provides high surface area for microbial growth, while exhibiting exterior dimensions sufficient to prevent such biocarrier media from passing through the apertures in the outer surface of bio-reactor container 22. Said biocarrier media is ideally inoculated with microbial population(s) beneficially tailored to the degradation of waste(s) to be encountered and treated within a particular environment, such as those encountered in effluent from septic tanks and other similar facilities.

This embodiment of the present invention functions in the following manner. As a waste stream enters septic tank 21, solid wastes 33 are separated from liquid wastes of said waste stream. Much, if not all, of such solid wastes will fall out in compartment 21a. Such liquid wastes will flow between compartments 21a and 21b of septic tank 21 via equalization tube 27. Thereafter, said liquid waste stream will be directed to compartment 21c via equalization tube 28 and flow tube 29. As such, compartment 21c of said septic tank 21, which houses bio-reactor 20, will comprise primarily liquid wastes and little, if any, solid waste content.

Bio-reactor container 22 is immersed in such liquid waste which permeates through microbially inoculated biocarrier 32. Beneficial microbial population(s) present on said inoculated biocarrier 32 come in contact with organic wastes present in said liquid waste stream. Such beneficial microbial population(s) act to mineralize such organic wastes, resulting in environmentally acceptable by-products (including, by way of illustration but not limitation, carbon dioxide and water). By the time that said liquid waste stream progresses through compartment 21c of septic tank 21, the bulk of said organic wastes become mineralized and broken down into such environmentally acceptable elements-.

In order to facilitate mineralization of wastes by beneficial microbial populations present on inoculated biocarrier 32, it is generally desirable that the liquid waste stream being treated have sufficient retention time within compartment 21c of septic tank 21 which houses bio-reactor container 22. Such retention time promotes contact between beneficial microbial populations and the wastes which are being treated, thereby facilitating desired mineralization of said wastes.

While the invention has been described in connection with its preferred embodiment, it will be understood that many modifications will be apparent to those of ordinary skill in the art in light of the above disclosure. Such modifications may include using substitute materials, smaller or greater dimensions, varying the number and placement of biocarrier media, using a variety of different aeration devices, and so forth, to achieve substantially the same results in substantially the same way. Reference to the following claims should be made to determine the scope of the invention.

What is claimed is:

1. A method of treating wastes supported in a liquid comprising:
a. Inoculating at least one carrier media with at least one microbial population;
b. Placing said at least one carrier media within a container having an inlet and an outlet;
c. Introducing said wastes into said container through said inlet;
d. Supplying oxygen to said container and said at least one microbial population; and
e. Permitting liquid to exit said container through said outlet.

2. The method of claim 1, further comprising the step of supplying at least one nutrient to said at least one microbial population.

3. The method of claim 2, wherein said at least one microbial population is spread throughout said waste supporting liquid by gas bubbles diffusing through said liquid.

4. An apparatus for treating wastes supported in a liquid comprising:
a. a container having an inlet and an outlet;
b. carrier media disposed within said container;
c. at least one microbial population inoculated on said carrier media; and
d. means for supplying oxygen to said at least one microbial population.

5. The apparatus of claim 4, further comprising means for supplying at least one nutrient to said at least one microbial population.

6. The apparatus of claim 4, wherein said means for supplying oxygen to said at least one microbial population comprises:
a. an oxygen source;
b. a diffuser disposed within said container; and
c. a conduit having a first end and a second end, wherein said first end is connected to said oxygen source and said second end is connected to said diffuser.

7. The apparatus of claim 6, wherein said oxygen source is an air compressor.

8. The apparatus of claim 5, wherein said means for supplying said at least one nutrient to said at least one microbial population comprises:
a. a nutrient source;
b. a diffuser disposed within said container; and
c. a conduit having a first end and a second end, wherein said first end is connected to said nutrient source and said second end is connected to said diffuser.
